(19) United States
(12) Patent Application Publication
(10) Pub. No.: US 2024/0143399 A1
(43) Pub. Date: May 2, 2024

(54) ALLOCATING COMPUTING RESOURCE CONSUMPTION UNITS

(71) Applicant: Microsoft Technology Licensing, LLC, Redmond, WA (US)

(72) Inventors: Prabhakaran SETHURAMAN, Redmond, WA (US); Srishty SAHA, Redmond, WA (US); Naveen Joel ISRAEL, Redmond, WA (US)

(21) Appl. No.: 18/052,075

(22) Filed: Nov. 2, 2022

(51) Int. Cl. G06F 9/50; G06F 11/34

(52) U.S. Cl. CPC G06F 9/5027; G06F 11/3442; G06F 2201/81

(57) ABSTRACT

The technology described herein manages the consumption of computing resources by assigning a first computing resource consumption threshold to an organization including entities, monitoring entity consumption levels of computing resources for each of the entities, wherein the entity consumption levels of computing resources for all of the entities sum to an organization consumption level for the entity, detecting, at a first time, that the organization consumption level exceeds the first computing resource consumption threshold assigned to the organization, determining a prorated share of the first computing resource consumption threshold for each entity based on the entity consumption level of each entity and the organization consumption level at the first time, assigning each prorated share of the computing resources consumption threshold to the corresponding entity, and receiving confirmation of acceptance of the prorated share assigned to each entity.

### BACKGROUND

Different entities within an organization (e.g., an enterprise) can consume computing resources at different levels during the same time interval. For example, ten software licenses may be deployed to the accounting department during the same period when only one software license is deployed to the legal department. A consumption monitoring service monitors the computing resource consumption levels within the organization.

### SUMMARY

The technology described herein manages the consumption of computing resources by assigning a first computing resource consumption threshold to an organization including entities, monitoring entity consumption levels of computing resources for each of the entities, wherein the entity consumption levels of computing resources for all of the entities sum to an organization consumption level for the organization, detecting, at a first time, that the organization consumption level exceeds the first computing resource consumption threshold assigned to the organization, determining a prorated share of the first computing resource consumption threshold for each entity based on the entity consumption level of each entity and the organization consumption level at the first time, assigning each prorated share of the computing resources consumption threshold to the corresponding entity, and receiving confirmation of acceptance of the prorated share assigned to each entity.

This summary is provided to introduce a selection of concepts in a simplified form that is further described below in the Detailed Description. This summary is not intended to identify key features or essential features of the claimed subject matter, nor is it intended to be used to limit the scope of the claimed subject matter.

Other implementations are also described and recited herein.

### BRIEF DESCRIPTIONS OF THE DRAWINGS

FIG. 1 illustrates an example system for prorated computing resource threshold assignment.

FIG. 2 illustrates another example system for prorated computing resource threshold assignment.

FIG. 3 illustrates example operations for prorated computing resource threshold assignment.

FIG. 4 illustrates an example computing device for implementing the features and operations of the described technology.

### DETAILED DESCRIPTIONS

In the described technology, a consumption monitoring service monitors the computing resource consumption by the entities of an enterprise, wherein an enterprise is an example organization that includes multiple entities (e.g., a multinational conglomerate that includes operational entities in different countries; a mid-sized manufacturing company that includes operational entities that perform different functions, such as manufacturing, legal, and human resources; a school district that includes different schools, different disciplines, and/or different grades, a charity with different retail facilities throughout a city). It should be understood that an organization may be a sub-grouping of entities within an enterprise or the entire enterprise. The consumption monitoring service also compares whether a computing resource consumption level of the enterprise exceeds a predetermined computing resource consumption threshold assigned to the enterprise. Static consumption monitoring services fail to apportion responsibility for the consumption of computing resources among the entities of the enterprise. In implementations, the enterprise manages each of the entities differently, such that static apportioning of the responsibility for the consumption of computing resources may be inappropriate.

The presently described technology monitors entity consumption levels of computing resources for each entity of an enterprise. The enterprise is assigned a first computing resource consumption threshold. When an enterprise's enterprise consumption level of computing resources exceeds the first resource consumption threshold, a prorated share of the first computing resource consumption threshold is dynamically assigned to each entity based on an enterprise consumption level of computing resources attributable to the entity relative to the enterprise consumption level of computing resources for the enterprise. In so doing, the responsibility for the consumption of computing resources is assigned to each of the entities in line with the consumption of each of the entities. This allows the enterprise to separately manage computing resources used by the entities.

In implementations, when a consumption monitor service detects that an enterprise consumption level of an enterprise exceeds a computing resource consumption threshold, the consumption monitoring service determines the prorated share of the computing resource threshold for each entity and then assigns a second computing resource threshold to the enterprise that is greater than the first computing resource threshold. In implementations in which the enterprise consumption level exceeds the second computing resource consumption threshold, the enterprise computing resource service determines the prorated share of the second computing resource threshold for each entity and then assigns a second computing resource threshold to the enterprise that is greater than the second computing resource threshold.

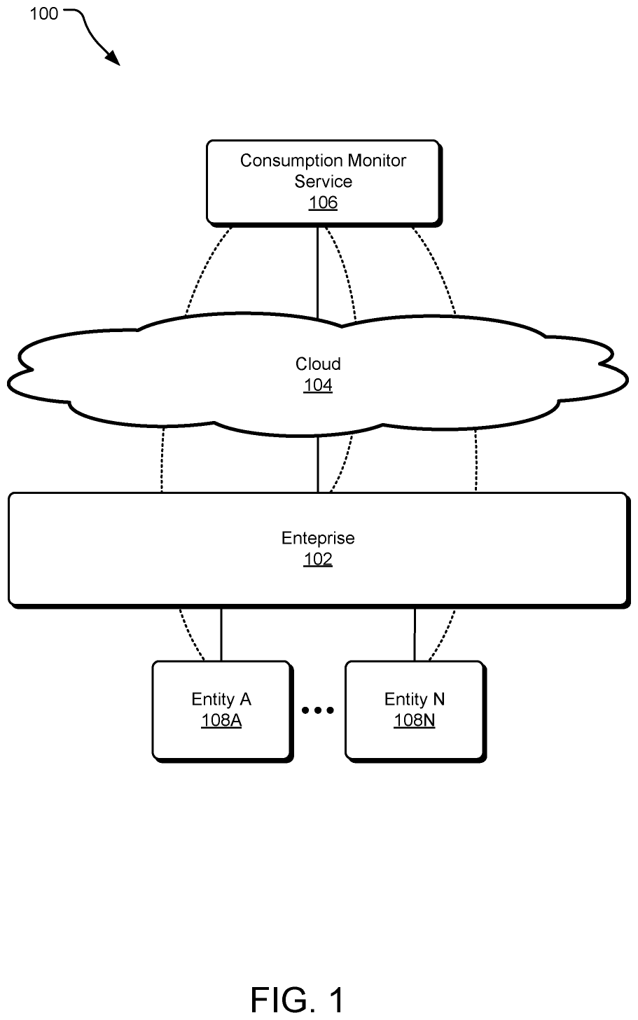

FIG. 1 illustrates an example system 100 for prorated computing resource threshold assignment. The system 100 includes a consumption monitoring service 106 that monitors the computing resource consumption of an enterprise 102. In implementations, the consumption monitoring service 106 monitors the internal consumption of computing resources within the enterprise 102. In another implementation, the consumption monitoring service 106 additionally or alternatively monitors the consumption of computing resources provided by a computing resource service provider to the enterprise 102.

The enterprise 102 (an example organization) includes entities 108A-N. The enterprise 102 and its entities 108A-N communicate with a resource consumption monitor of the consumption monitor service 106. While illustrated as a separate element, implementations are contemplated in which the consumption monitor service 106 is an element of the enterprise 102 or one or more of the entities 108A-N. In an implementation, the enterprise exercises at least some degree of control over the entities 108A-N. Examples of the entities 108A-N include subsidiaries, departments, or divisions of the enterprise 102. In implementations, the enterprise 102 can be an organization or sub-organization (e.g., the enterprise 102 can be a whole company or can be an organization or a division, such as a regional or other division, or can be a subsidiary within a company) with control over the entities 108A-N (e.g., the entities 108A-N control different aspects of the enterprise 102, such as research and development, order fulfillment, or customer service, or the entities 108A-N represent sub-divisions or subsidiaries of the enterprise 102). The entities 108A-N include computing systems that consume computing resources.

The consumption monitor service 106 monitors an enterprise consumption level of computing resources utilized by the entirety of the enterprise 102 and monitors entity consumption levels of computing resources consumed by each of the entities 108A-N. In an implementation in which the enterprise consumption level represents a sum of the entity consumption levels, the consumption monitor service 106 sums the entity consumption levels to determine the enterprise consumption level by summation. Computing resources consumed can be represented by a consumption metric, such as a consumption unit.

In an implementation, the consumption monitor service 106 assigns to the entity a computing resource consumption threshold. The computing resource consumption threshold represents a limit (e.g., expressed as consumption units) on the enterprise consumption level by the enterprise 102 before an accounting is made for computing resource consumption. The computing resource consumption threshold may be assigned based on reliability factors. Examples of reliability factors include a history of the enterprise consumption level; a capacity of the enterprise 102 to maintain the enterprise consumption level within limits manageable by the enterprise 102 or the entities 108A-N; the determined risk associated with providing the computing resources for consumption by the enterprise 102; an internally imposed limit imposed by the enterprise 102 on an entity 108A-N; and the like.

In implementations, the consumption monitor service 106 detects that an enterprise consumption level exceeds an assigned computing resource consumption threshold at a first time. The consumption monitoring service 106 then determines a prorated share of the first computing resource consumption threshold for each of the entities 108A-N based on the entity consumption level of each of the entities 108A-N and the enterprise consumption level at the first time. The consumption monitor service 106 then assigns each prorated share of the computing resource threshold to the corresponding entity 108A-N. In implementations, the prorated shares are dynamically determined proportionally (e.g., by a relative ratio or percentage) to the computing resources used by each of the entities 108A-N between a prior predefined time (e.g., at the beginning of a monitoring period) and the first time. In this implementation, the prorated shares represent a relative responsibility of the entities 108A-N for the consumption of the computing resources (e.g., as represented in consumption units) up to the computing resource consumption threshold.

The enterprise 102 may be responsible or obligated to immediately or within a predefined amount of time account for the consumption of the computing resources when the enterprise consumption level exceeds the computing resource consumption threshold. As described herein, accounting for computing resources consumed can include remitting or otherwise reconciling accounts for the computing resources consumed.

In other static systems, no prorated shares of the computing resource consumption threshold are assigned to entities of a different enterprise, or the prorated shares are distributed (e.g., evenly) without regard to the values of the entity consumption levels relative to the enterprise consumption level of the different enterprise. This complicates individual management by the different enterprise of computing resource consumption by the entities of the different enterprise. By contrast, implementations of the described technology are contemplated in which the enterprise 102 provides different remitting means for some or all of the entities 108A-N. The different remitting means each remit under different terms. In these implementations, the enterprise 102 can better control by which of the remitting methods the prorated shares of the computing resource consumption threshold are remitted. That is, the dynamic assignment of prorated shares of the computing resource consumption threshold for which the enterprise 102 is responsible at the first time effectively allows the enterprise 102 to distribute the responsibility in a manner commensurate with expected entity consumption levels. The enterprise 102 can, therefore, better plan how the entities 108A-N consume computing resources and/or determine remitting methods to assign for each of the entities 108A-N. This can provide the enterprise 102 greater flexibility in managing internal computing resource usage by the entities 108A-N.

In an implementation, the consumption monitoring service 106 is configured to assign computing resource consumption thresholds. For example, the consumption monitoring service 106 assigns an initial or first computing resource consumption threshold. The initial computing resource consumption threshold is a default value or is determined by the consumption monitor service 106 based on data representing the trustworthiness or reliability of the enterprise 102. For example, if the enterprise 102 has a history of remitting for computing resources consumed or if the consumption monitor service 106 has data that the enterprise 102 is able to remit for computing resources consumed, the consumption monitor service 106 is more likely to provide a higher resource consumption threshold.

Computing resource consumption thresholds provide the enterprise 102 peace of mind, as the resource consumption threshold ensures that the enterprise 102 is not expected to account for more than the resource consumption threshold within a first predefined duration (e.g., a first monitoring period as described herein). If the computing resource consumption threshold is not exceeded within the first predefined duration, the enterprise 102 accounts for the enterprise consumption level at the end of the first predefined duration. If the computing resource consumption threshold is exceeded within the first predefined duration, the enterprise 102 is expected to account for a portion of the enterprise consumption level up to the computing resource consumption threshold (e.g., prorated shares of which are assigned to the entities 108A-N). The remainder of the enterprise consumption level is carried to a second predefined duration (e.g., a second subsequent monitoring period).

In implementations, the consumption monitor service 106 assigns updated computing resource consumption thresholds to the enterprise 102. For example, if an enterprise consumption level exceeds an existing computing resource consumption threshold, such as the first computing resource consumption threshold, the consumption monitor service 106 determines that the existing first computing resource consumption threshold is insufficient to cover the latest enterprise consumption level of the enterprise 102. In an implementation, the consumption monitor service 106 then assigns a second computing resource consumption threshold that is greater than the first computing resource consumption threshold. Examples of factors in determining the difference between the second computing resource consumption threshold and the first computing resource consumption threshold include a difference between the first computing resource threshold and the enterprise consumption level at a second time at which the consumption monitor service 106 assigns the second computing resource consumption threshold; a predefined threshold increase buffer (e.g., that is static or is dynamic but predefined based on factors, such as the trustworthiness or reliability of the enterprise 102 as described); a dynamically determined increase (e.g., determined based on the trustworthiness or reliability of the enterprise 102 as described); the first computing resource consumption threshold; and an initial computing resource consumption threshold initially assigned to the enterprise 102.

The durations for monitoring computing resource consumption or assigning new thresholds can coincide or can differ. In an implementation, the duration at the end of which the enterprise 102 is responsible for accounting for an amount of the enterprise consumption level that does not reach the current computing resource consumption threshold is a monitoring period. If the computing resource consumption threshold is reached during the monitoring period, the enterprise 102 is responsible for accounting for the enterprise consumption level up to the computing resource consumption threshold and is responsible for any amounts remaining at the end of the monitoring period. Implementations are contemplated in which consumption monitor service 106 can redetermine the computing resource consumption threshold at any threshold redetermination period, including ones that coincide with the monitoring period or ones that do not. In implementations, the computing resource consumption threshold is redetermined responsive to the enterprise consumption level exceeding the computing resource consumption threshold at a first time within a monitoring duration.

In an implementation, despite the consumption monitor service 106 determining a second computing resource consumption threshold within a first monitoring period in which the enterprise consumption level exceeded a first computing resource consumption threshold, the enterprise 102 may only be responsible for accounting for the amounts of the first computing resource consumption threshold during the monitoring period. In essence, in this implementation, despite the consumption monitor service 106 determining the higher second computing resource consumption threshold during the monitoring period, the higher second computing resource consumption threshold is applied to a second subsequent monitoring period. In an alternative implementation, the second computing resource consumption threshold is determined at the end of the first monitoring period (e.g., at a second time) based on the enterprise consumption level that remained at the end of the first monitoring period (e.g., after the enterprise 102 accounted for the enterprise consumption level up to the first computing resource consumption threshold).

Various implementations of consumption metrics (e.g., consumption units) by which the enterprise consumption level, the entity consumption levels, and/or the computing resource consumption threshold are measured are contemplated. In an implementation, the consumption metrics represent the quality or magnitude of computing resources. Examples of computing resources include the number of processors, specifications of processors (e.g., cores, threads, cache, speed/frequency, etc.), the number of memory devices, amount of memory, specifications of memory (e.g., latency, speed, frequency, distance from a processor), access to or use of applications supplied by the enterprise computing service, and the like. In an implementation, consumption metrics are based on predefined values and/or relative weights assigned to different computing resources consumed. For example, the consumption of four six-core processors for an hour represents seven consumption units, the consumption of three eight-core processors for an hour represents eight consumption units, and the consumption of an application (e.g., acquisition of a license to use the application) represents ten consumption units. Alternatively or additionally, the consumption units can represent or otherwise map to remittance amounts (e.g., fees charged by a computing resource service provider).

In implementations, the consumption monitor service 106 detects that the enterprise consumption level (e.g., including a sum of the entity consumption levels) exceeds the second computing resource consumption threshold at a second time. The consumption monitor service 106 then determines an adjusted prorated share, which is a prorated share of the second computing resource consumption threshold and assigns the prorated share to each of the entities 108A-N based on the entity consumption level of each of the entities 108A-N and the enterprise consumption level at the second time. In an implementation, the enterprise 102 is responsible or obligated to immediately or within a predefined amount of time account for the consumed computing resources when the enterprise consumption level exceeds the computing resource consumption threshold.

In an implementation, after the prorated shares have been assigned, the consumption monitor service 106 receives a confirmation of acceptance of the prorated share assigned to each entity 108A-N. In an implementation, the consumption monitor service 106 receives data representing that remitting has occurred consistent with the prorated share assignments to the entities 108A-N. For example, in implementations, the consumption monitor service 106 uses different remitting methods for the different entities to remit from the remitting method of each entity 108A-N, the prorated share of the first computing resource consumption threshold associated with the entity 108A-N. In an implementation, entity consumption managers receive data representing the remitting amounts and methods. In an implementation, the received confirmation of acceptance of the prorated share assigned to each entity 108A-N is received from the entity consumption managers. Entity consumption managers are configured to process remittances; submit accounting reports of computing resources and/or consumption units consumed by the entities 108A-N; or provide (e.g., transmit) confirmations of acceptance of the provided shares to the enterprise 102, a computing resource service provider (if the computing resources consumed are provided by the computing resource service provider) and/or the consumption monitor service 106. In implementations, the enterprise 102 controls which remitting methods are used by which entity consumption managers.

In another implementation, the entity consumption managers are elements of the enterprise 102 and are used to account for the consumption of enterprise computing resources within the enterprise. In this implementation, the entity consumption managers control messaging related to the computing resource consumption by the entities 108A-N within the enterprise 102 and/or with the consumption monitor service 106.

In an example implementation of system 100, the enterprise 102 has previously been assigned a first computing resource consumption threshold of 600 consumption units. During a first monitoring period, at a first time, the enterprise consumption level is increased to 3,490 consumption units. The enterprise 102 is presently responsible to account for the 600 consumption units represented by the first computing resource consumption threshold. The first entity of the entities 108A-N is responsible for consuming 190 consumption units (e.g., about 5.4% of the enterprise consumption level). The second entity of the entities 108A-N is responsible for consuming 3,300 consumption units (e.g., about 94.6% of the enterprise consumption level). The consumption monitor service 106 determines that the proportional prorated shares assigned to the first entity and the second entity of the first computing resource consumption threshold are 33 consumption units (e.g., about 5.4%) and 567 consumption units (e.g., about 94.6%), respectively, based on the proportional relative consumption of the computing resource by the first entity and the second entity. The enterprise 102 will then account for the remainder of the consumption units (e.g., 2890 consumption units and/or any other consumption units consumed during the remainder of the monitoring period) at the end of the monitoring period.

In an implementation, because the first computing resource consumption threshold was exceeded, a consumption threshold manager of the consumption monitoring service 106 assigns a second computing resource consumption threshold greater than the first computing resource consumption threshold. The second computing resource consumption threshold can be set to a level higher than the enterprise consumption level at the first time. For example, the consumption threshold manager assigns the second computing resource consumption threshold at 3600 consumption units to ensure that the second computing resource consumption threshold is sufficiently high to account in a new monitoring period for the consumption during the first monitoring period. The 3600 consumption unit second computing resource consumption threshold includes the 3490 consumption units from the prior period and another 110 consumption units as a threshold increase buffer. The threshold increase buffer includes a rule to round up to the nearest hundred consumption units (e.g., 3500 consumption units) and to add a further 100 consumption units above that.

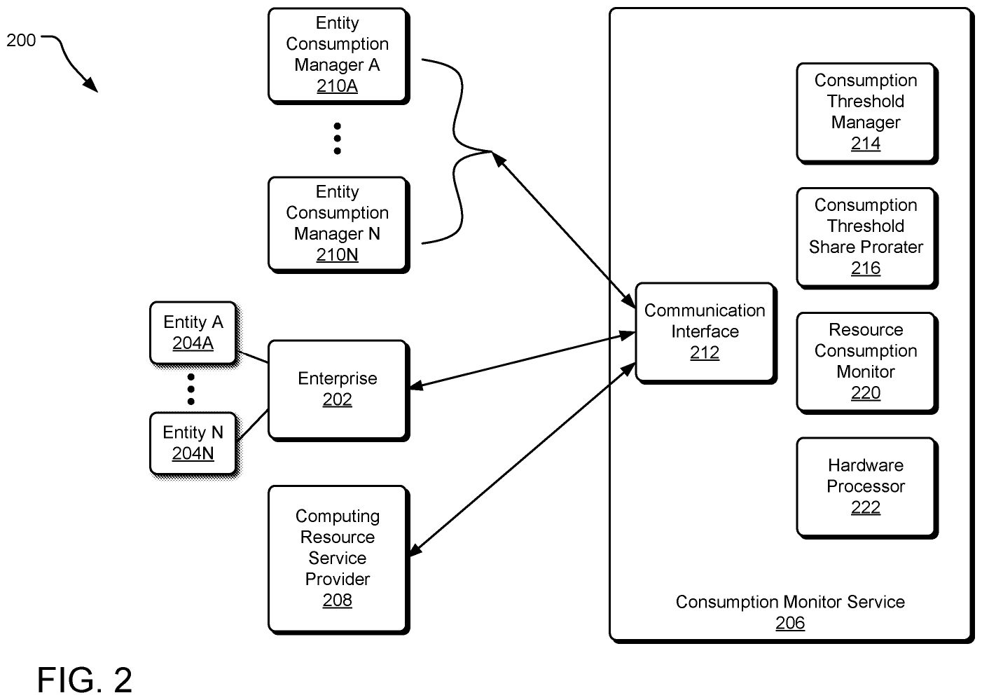

FIG. 2 illustrates another example system 200 for prorated computing resource threshold assignment. The system 200 includes an enterprise 202. The enterprise 202 includes entities 204A-N that consume computing resources. A consumption monitoring service 206 monitors the computer resource consumption by the entities 204A-N. In an implementation, the computing resources monitored are provided from within enterprise 202 to the entities 204A-N. In another implementation, the computing resources monitored are, additionally or alternatively, provided by a computing resource service provider 208.

While illustrated as a single system, in other implementations, implementations are contemplated in which the enterprise 202 is distributed over a number of computing devices in different locations. While the entities 204A-N are illustrated as communicating with the consumption monitor service 206 through the enterprise 202, implementations are contemplated in which one or more of the entities 204A-N individually communicate directly with the communication interface 212 or the entity communication interface 204 via dedicated entity communication interfaces of the entities 204A-N.

In an implementation, the consumption monitor service 206 communicates with entity consumption managers 210A-N. The entity consumption managers 210A-N each correspond to one or more of the entities 204A-N. The entity consumption managers 210A-N are configured to account for computing resource consumption based on the monitoring by the consumption monitor service 206.

In the illustrated implementation, the consumption monitor service 206 includes a consumption threshold manager 214, a consumption threshold share prorater 216, or a hardware processor 222.

The resource consumption monitor 218 monitors enterprise consumption levels of computing resources by the enterprise 202 and entity consumption levels of computing resources by the entities 204A-N. The consumption threshold manager 214 assigns a computing resources consumption threshold to the entity of the enterprise 202. The resource consumption monitor 218 detects when the enterprise consumption levels exceed the assigned computing resource consumption threshold.

In an implementation, the detection by the resource consumption monitor 230 that the enterprise consumption level exceeds the assigned computing resource consumption threshold causes (e.g., by trigger or notification) one or more detection response actions. Examples of detection response actions include notifying the enterprise 202 that the computing resource consumption threshold has been exceeded; causing a consumption threshold share prorater 216 to assign prorated shares of the computing resource consumption threshold to the entities 204A-N; causing the entity consumption managers 210A-N to account for the computing resource consumption threshold; or causing the consumption threshold manager 214 to assign a new computing resource consumption threshold to the enterprise 202.

In an implementation, the resource consumption monitor 218 detects that the enterprise consumption level exceeds the assigned computing resource consumption threshold at a first time. The resource consumption monitor 220 is configured to cause a consumption threshold share prorater 216 to assign prorated shares of the computing resource consumption threshold to the entities 204A-N in response to the detection. In this implementation, in response to the detection, the consumption threshold share prorater 216 determines a prorated share of the first computing resource consumption threshold for each of the entities 204A-N based on the entity consumption level of each of the entities tracked by the resource consumption monitor 220. The consumption threshold share prorater 216 then assigns each prorated share of the computing resource threshold to the corresponding entity. The prorated shares may be assigned to the entity consumption managers 210A-N. In implementations, the prorated shares are dynamically determined proportionally (e.g., by a relative ratio or percentage) to the computing resources used by each of the entities 204A-N between a prior predefined time (e.g., the beginning or a current monitoring period) and the first time. In this implementation, the prorated shares represent a relative responsibility of the entities 204A-N for the use of the computing resources up to the computing resource consumption threshold.

In an implementation, the resource consumption monitor 218, in response to the detection, causes the entity consumption managers 210A-N to account for computing resources consumed. For example, at the first time, the enterprise 202 may be responsible or obligated to immediately or within a predefined amount of time account for the consumption of the computing resources when the enterprise consumption level exceeds the computing resource consumption threshold.

In an implementation, the consumption threshold manager 214 assigns a first computing resource consumption threshold. In an implementation, the first computing resource consumption threshold is an initial computing resource consumption threshold or a computing resource consumption threshold assigned subsequently relative to the assignment of the initial computing resource consumption threshold, as described herein. In implementations, the detection by the resource consumption monitor 218 that the enterprise consumption level exceeds the first computing resource consumption threshold causes the consumption threshold manager 214 to assign updated computing resource consumption thresholds to the enterprise 202. For example, if an enterprise consumption level exceeds an existing computing resource consumption threshold, such as the first computing resource consumption threshold, the consumption threshold manager 214 determines that the existing first computing resource consumption threshold is insufficient to cover the latest enterprise consumption level. The consumption threshold manager 214 then assigns a second computing resource consumption threshold that is greater than the first computing resource consumption threshold to the entity, as described herein.

In implementations, the resource consumption monitor 218 detects that the enterprise consumption level (e.g., including a sum of the entity consumption levels) exceeds the second computing resource consumption threshold at a second time. The enterprise computing resource service then determines a prorated share of the second computing resource consumption threshold for and assigns the prorated share to each of the entities and/or the entity consumption managers 210A-N based on the entity consumption level of each of the entities and the enterprise consumption level at the second time. The enterprise 202 may be responsible or obligated (e.g., by agreement) to immediately (or within a predefined amount of time) account for the consumed computing resources when the enterprise consumption level exceeds the computing resource consumption threshold.

In implementations, one or more of the entity consumption managers 210A-N, consumption threshold manager 214, resource consumption monitor 218, or consumption threshold share prorater 216 can be executed using specialized hardware, can be stored in memory and executed by the hardware processor 222, or can be executed by a combination thereof.

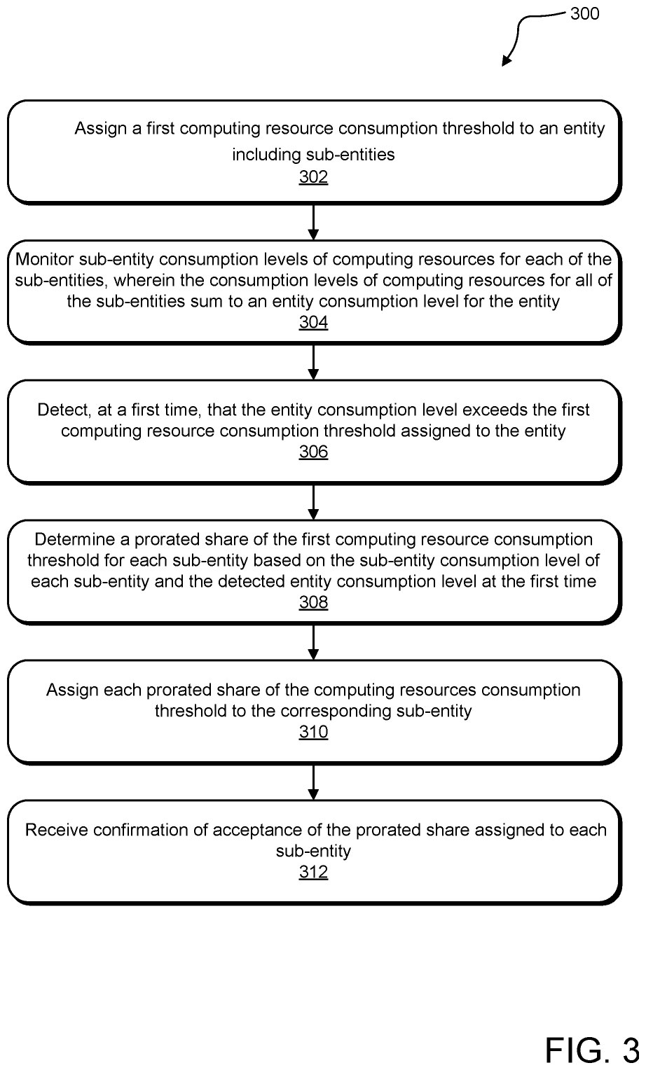

FIG. 3 illustrates example operations 300 for prorated computing resource threshold assignment. An assignment operation 302 assigns a first computing resource consumption threshold to an enterprise, including entities. In implementations, the computing resources consumed are provided by the enterprise and/or a computing resource service provider.

In an implementation, the first computing resource consumption threshold is determined by the consumption monitoring service based on data representing the trustworthiness or reliability of the enterprise, as described herein. In an implementation, the enterprise alternatively or additionally provides the computing resources consumed by the entities, and the first consumption resource threshold is set to monitor the consumption of the entities for internal management.

A monitoring operation 304 monitors entity consumption levels of computing resources for each of the entities using a resource consumption monitor of the consumption monitor service. In an implementation, the consumption levels of computing resources for all of the entities sum to an enterprise consumption level for the entity.

A detecting operation 306 detects, at a first time, that the enterprise consumption level exceeds the first computing resource consumption threshold assigned to the enterprise. When the detecting operation 306 detects that the enterprise consumption level exceeds the current computing resource consumption threshold within the first predefined duration, the entity is responsible or obligated to account for a portion of the enterprise consumption level up to the computing resource consumption threshold (e.g., prorated shares of which are assigned to the entities). The enterprise and entities account for the remainder of the enterprise consumption level above the first computing resource consumption threshold at the end of the current monitoring period.

A determining operation 308 determines a prorated share of the first computing resource consumption threshold for each entity based on the entity consumption level of each entity and the enterprise consumption level at the first time. The resource consumption monitor monitors entity consumption levels of computing resources consumed by each of the entities. In implementations, the prorated shares are dynamically determined proportionally to the computing resources used by each of the entities between a prior predefined time and the first time. In this implementation, the prorated shares represent a relative responsibility of the entities for consumption of the computing resources up to the computing resource consumption threshold.

An assigning operation 310 assigns each prorated share of the computing resources consumption threshold to the corresponding entity. The assigning operation assigns each determined prorated share of the computing resource threshold to the corresponding entity. The dynamic assignment of prorated shares of the computing resource consumption threshold for which the enterprise is responsible at the first time effectively allows the enterprise to distribute the responsibility to the entities in a manner commensurate with expected entity consumption levels. Consequently, the enterprise can better plan how the entities will be allowed to consume computer resources and/or which remitting methods to assign to each of the entities. The proration of shares of the computing resource consumption threshold can also provide the enterprise greater flexibility in managing internal computing resource usage by the entities in implementations in which the enterprise provides the computing resources to the entities.

A receiving operation 312 receives a confirmation of acceptance of the prorated share assigned to each entity. The receiving operation 312 receives data representing that remitting has occurred consistently with the prorated share assignments to the entities. For example, in implementations, the receiving operation 312 uses remitting methods for the different entities to remit from each entity its prorated share of the first computing resource consumption threshold. The remitting and/or transmission of the confirmation of acceptance can be accomplished by the entity consumption managers associated with the entities (e.g., assigned by the enterprise to the entities).

In implementations, a further assignment operation (not illustrated) assigns updated computing resource consumption thresholds to the enterprise (e.g., during the first monitoring period, at the termination of the first monitoring period, or during the second monitoring period). For example, if an enterprise consumption level exceeds an existing computing resource consumption threshold, such as the first computing resource consumption threshold, the further assignment operation determines that the existing first computing resource consumption threshold is insufficient to cover the latest enterprise consumption level of the enterprise. In an implementation, this determination is made when the resource consumption monitor detects that the enterprise consumption level exceeds the first computing resource consumption threshold. The consumption monitor service then assigns a second computing resource consumption threshold that is greater than the first computing resource consumption threshold, as described herein.

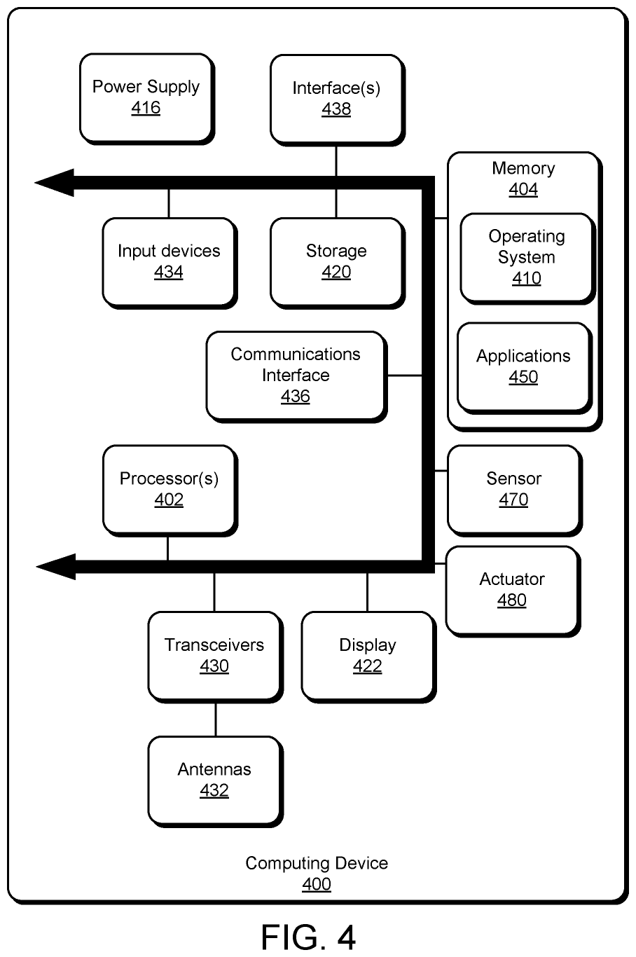

FIG. 4 illustrates an example computing device 400 for implementing the features and operations of the described technology. The computing device 400 may embody a remote-control device or a physical controlled device and is an example network-connected and/or network-capable device and may be a client device, such as a laptop, mobile device, desktop, tablet; a server/cloud device; an internet-of-things device; an electronic accessory; or another electronic device. The computing device 400 includes one or more processor(s) 402 and a memory 404. The memory 404 generally includes both volatile memory (e.g., RAM) and nonvolatile memory (e.g., flash memory). An operating system 410 resides in the memory 404 and is executed by the processor(s) 402.

In an example computing device 400, as shown in FIG. 4, one or more modules or segments, such as automated actuator protocols, applications 450, [an entity consumption manager, an entity consumption manager, a consumption threshold manager, a resource consumption monitor, or a consumption threshold share prorater, are loaded into the operating system 410 on the memory 404 and/or storage 420 and executed by processor(s) 402. The storage 420 may include one or more tangible storage media devices and may store a confirmation of acceptance of a prorated share of a computing resource consumption threshold, a computing resource consumption threshold, an enterprise consumption level, an entity consumption level, a predefined threshold increase buffer, a predefined time, a predefined duration, a predefined consumption score values, a predefined consumption weight, a predefined remittance value, locally and globally unique identifiers, requests, responses, and other data and be local to the computing device 400 or may be remote and communicatively connected to the computing device 400.

The computing device 400 includes a power supply 416, which is powered by one or more batteries or other power sources and which provides power to other components of the computing device 400. The power supply 416 may also be connected to an external power source that overrides or recharges the built-in batteries or other power sources.

The computing device 400 may include one or more communication transceivers 430, which may be connected to one or more antenna(s) 432 to provide network connectivity (e.g., mobile phone network, Wi-Fi®, Bluetooth®) to one or more other servers and/or client devices (e.g., mobile devices, desktop computers, or laptop computers). The computing device 400 may further include a communications interface 436 (e.g., a network adapter), which is a type of computing device. The computing device 400 may use the communications interface 436 and any other types of computing devices for establishing connections over a wide-area network (WAN) or local-area network (LAN). It should be appreciated that the network connections shown are examples and that other computing devices and means for establishing a communications link between the computing device 400 and other devices may be used.

The computing device 400 may include one or more input devices 434 such that a user may enter commands and information (e.g., a keyboard or mouse). These and other input devices may be coupled to the server by one or more interfaces 438, such as a serial port interface, parallel port, or universal serial bus (USB). The computing device 400 may further include a display 422, such as a touchscreen display.

In implementations in which the computing device 400 includes or is an automated (e.g., robotic) device, the computing device 400 may include an actuator 480 adapted to engage elements of the apparatuses disclosed herein. The actuator 480 may be operable to perform operations disclosed herein (e.g., by executing by the processor(s) 402 automated actuator protocols stored in the storage 420 and/or the memory 404). The actuator 480 may be operated in conjunction with a sensor 470 to use detections of the sensor 470 to guide the motion of the actuator 480 in a feedback loop.

The computing device 400 may include a variety of tangible processor-readable storage media and intangible processor-readable communication signals. Tangible processor-readable storage can be embodied by any available media that can be accessed by the computing device 400 and includes both volatile and nonvolatile storage media, removable and non-removable storage media. Tangible processor-readable storage media excludes communications signals (e.g., signals per se) and includes volatile and nonvolatile, removable and non-removable storage media implemented in any method or technology for storage of information such as processor-readable instructions, data structures, program modules, managers, or other data. Tangible processor-readable storage media includes, but is not limited to, RAM, ROM, EEPROM, flash memory or other memory technology, CDROM, digital versatile disks (DVD) or other optical disk storage, magnetic cassettes, magnetic tape, magnetic disk storage, or other magnetic storage devices, or any other tangible medium which can be used to store the desired information and which can be accessed by the computing device 400. In contrast to tangible processor-readable storage media, intangible processor-readable communication signals may embody processor-readable instructions, data structures, program modules, managers, or other data resident in a modulated data signal, such as a carrier wave or other signal transport mechanism. The term “modulated data signal” means a signal that has one or more of its characteristics set or changed in such a manner as to encode information in the signal. By way of example, and not limitation, intangible communication signals include signals traveling through wired media such as a wired network or direct-wired connection, and wireless media such as acoustic, RF, infrared, and other wireless media.

Various software components described herein are executable by one or more processors, which may include logic machines configured to execute hardware or firmware instructions. For example, the processors may be configured to execute instructions that are part of one or more applications, services, programs, routines, libraries, objects, components, data structures, or other logical constructs. Such instructions may be implemented to perform a task, implement a data type, transform the state of one or more components, achieve a technical effect, or otherwise arrive at a desired result.

Aspects of processors and storage may be integrated together into one or more hardware logic components. Such hardware-logic components may include field-programmable gate arrays (FPGAs), program- and application-specific integrated circuits (PASIC/ASICs), program-specific and application-specific standard products (PSSP/ASSPs), system-on-a-chip (SOC), and complex programmable logic devices (CPLDs), for example.

The terms “module,” “program,” “manager,” and “engine” may be used to describe an aspect of a remote-control device and/or a physically controlled device implemented to perform a particular function. It will be understood that different modules, programs, and/or engines may be instantiated from the same application, service, code block, object, library, routine, API, function, etc. Likewise, the same module, program, and/or engine may be instantiated by different applications, services, code blocks, objects, routines, APIs, functions, etc. The terms “module,” “program,” “manager,” and “engine” may encompass individual or groups of executable files, data files, libraries, drivers, scripts, database records, etc.

An example method of managing consumption of computing resources is provided. The method includes assigning a first computing resource consumption threshold to an organization including entities; monitoring entity consumption levels of computing resources for each of the entities, wherein the entity consumption levels of computing resources for all of the entities sum to an organization consumption level for the organization; detecting, at a first time, that the organization consumption level exceeds the first computing resource consumption threshold assigned to the organization; determining a prorated share of the first computing resource consumption threshold for each entity based on the entity consumption level of each entity and the organization consumption level at the first time; assigning each prorated share of the first computing resources consumption threshold to the corresponding entity; and receiving confirmation of acceptance of the prorated share assigned to each entity. Assigning prorated shares of computing resource consumption thresholds to entities controlled by an organization can improve computing resource allocation and utilization tracking for the organization.

Another example method of any preceding method is provided, further including assigning, at a second time after the first time, a second computing resource consumption threshold to the organization based on a difference between the organization consumption level at the second time and the first computing resource consumption threshold. If a computing resource consumption threshold is exceeded, it demonstrates that the organization is likely to use more resources within a predefined duration and should likely have a different threshold at which the organization is made aware that the consumption of computing resources has exceeded it. The remaining balance after the prior threshold is accounted for is a reasonable basis for an increase in the computing resource consumption threshold.

Another example method of any preceding method is provided, further including assigning, at a second time after the first time, a second computing resource consumption threshold greater than the first computing resource consumption threshold to the organization based on the operation of detecting. If a computing resource consumption threshold is exceeded, it demonstrates that the organization is likely to use more resources within a predefined duration and should likely have a greater threshold at which the organization is made aware that the consumption of computing resources has exceeded it.

Another example method of any preceding method is provided, wherein the determined prorated share of the first computing resource consumption threshold for each entity is determined based on each entity consumption level relative to the organization consumption level. Assigning a prorated share of responsibility for the computing resource consumption threshold based on an entity's relative consumption can appropriately attribute responsibility for the consumption of computing resources to the entity. This may be a proportionate assignment in which the prorated share represents a proportional share (e.g., a share ratio defined by the entity consumption level divided by the organization consumption level.

Another example method of any preceding method is provided, further including assigning, at a second time after the first time, a second computing resource consumption threshold based on the operation of detecting, wherein a difference between the second computing resource consumption threshold and the first computing resources consumption threshold includes a predefined threshold increase buffer. If a computing resource consumption threshold is exceeded, it demonstrates that the organization is likely to use more resources within a predefined duration and should likely have a different threshold at which the organization is made aware that the consumption of computing resources has exceeded it. A predefined increase buffer is a reasonable basis for an increase in the computing resource consumption threshold. The predefined increase buffer can be static or dynamic and can potentially better represent an organization's likely usage if the organization exceeded the threshold in a prior monitoring period by an uncharacteristically large margin.

Another example method of any preceding method is provided, further including transmitting, at the first time, to the organization, data representing that the first computing resource consumption threshold was exceeded. Informing the organization that the computing resource consumption threshold has been exceeded can provide the organization with a notice that consumption of computing resources has exceeded expectations and/or that redistributing or limiting the consumption of computing resources (e.g., among the entities) could benefit the organization.

Another example method of any preceding method is provided, further including associating each entity with an entity consumption manager, wherein the received confirmation of acceptance of the prorated share assigned to each entity is received based on data stored in each associated entity consumption manager. Using entity consumption managers to individually track the consumption of computing units for each entity can allow the assignment of the prorated shares to be based on the tracked consumption.

An example system for managing consumption of computing resources is provided. The system includes one or more hardware processors; a consumption threshold manager executable by the one or more hardware processors and configured to assign a first computing resource consumption threshold to an organization, the organization including entities; a resource consumption monitor executable by the one or more hardware processors and configured to: monitor entity consumption levels of computing resources for each of the entities, wherein the entity consumption levels of computing resources for all of the entities sum to an organization consumption level for the organization; and detect, at a first time, that the organization consumption level exceeds the first computing resource consumption threshold assigned to the organization; and a consumption threshold share prorater executable by the one or more hardware processors and configured to: determine a prorated share of the first computing resource consumption threshold for each entity based on the entity consumption level of each entity and the organization consumption level at the first time; assign each prorated share of the first computing resources consumption threshold to the corresponding entity; and receiving confirmation of acceptance of the prorated share assigned to each entity.

Another example system of any preceding system is provided, wherein the consumption threshold manager is further configured to assign, at a second time after the first time, a second computing resource consumption threshold to the organization based on a difference between the organization consumption level at the second time and the first computing resource consumption threshold.

Another example system of any preceding system is provided, wherein the consumption threshold manager is further configured to assign, at a second time after the first time, a second computing resource consumption threshold greater than the first computing resource consumption threshold to the organization based on the detection.

Another example system of any preceding system is provided, wherein the consumption threshold share prorater determines the prorated share of the first computing resource consumption threshold for each entity is based on each entity consumption level relative to the organization consumption level.

Another example system of any preceding system is provided, wherein the consumption threshold manager is further configured to assign, at a second time after the first time, a second computing resource consumption threshold based on the detection, wherein a difference between the second computing resource consumption threshold and the first computing resources consumption threshold includes a predefined threshold increase buffer.

Another example system of any preceding system is provided, wherein the resource consumption monitor is further configured to: transmit, at the first time, to the organization, data representing that the first computing resources consumption threshold was exceeded.

Another example system of any preceding system is provided, further including an entity consumption manager associated with each entity, wherein the received confirmation of acceptance of the prorated share assigned to each entity is received based on data stored in each associated entity consumption manager.

One or more example tangible processor-readable storage media devices encoding processor-executable instructions for executing on an electronic computing device a process of managing consumption of computing resources is provided. The process includes assigning a first computing resource consumption threshold to an organization, the organization including entities; monitoring entity consumption levels of computing resources for each of the entities, wherein the entity consumption levels of computing resources for all of the entities sum to an organization consumption level for the organization; detecting, at a first time, that the organization consumption level exceeds the first computing resource consumption threshold assigned to the organization; determining a prorated share of the first computing resource consumption threshold for each entity based on the entity consumption level of each entity and the organization consumption level at the first time; assigning each prorated share of the first computing resources consumption threshold to the corresponding entity; and receiving confirmation of acceptance of the prorated share assigned to each entity.

One or more other example tangible processor-readable storage media devices of any preceding devices, the process further including assigning, at a second time after the first time, a second computing resource consumption threshold to the organization based on a difference between the organization consumption level at the second time and the first computing resource consumption threshold.

One or more other example tangible processor-readable storage media devices of any preceding devices, wherein the determined prorated share of the first computing resource consumption threshold for each entity is determined based on each entity consumption level relative to the organization consumption level.

One or more other example tangible processor-readable storage media devices of any preceding devices, the process further including assigning, at a second time after the first time, a second computing resource consumption threshold greater than the first computing resource consumption threshold to the organization based on the detection.

One or more other example tangible processor-readable storage media devices of any preceding devices, the process further including assigning, at a second time after the first time, a second computing resource consumption threshold based on the detection, wherein a difference between the second computing resource consumption threshold and the first computing resources consumption threshold includes a predefined threshold increase buffer.

One or more other example tangible processor-readable storage media devices of any preceding devices, the process further including associating each entity with an entity consumption manager, wherein the received confirmation of acceptance of the prorated share assigned to each entity is received based on data stored in each associated entity consumption manager.

An example system for managing consumption of computing resources is provided. The system includes means for assigning a first computing resource consumption threshold to an organization including entities; means for monitoring entity consumption levels of computing resources for each of the entities, wherein the entity consumption levels of computing resources for all of the entities sum to an organization consumption level for the organization; means for detecting, at a first time, that the organization consumption level exceeds the first computing resource consumption threshold assigned to the organization; means for determining a prorated share of the first computing resource consumption threshold for each entity based on the entity consumption level of each entity and the organization consumption level at the first time; means for assigning each prorated share of the first computing resources consumption threshold to the corresponding entity; and means for receiving confirmation of acceptance of the prorated share assigned to each entity.

Another example system of any preceding system is provided, further including means for assigning, at a second time after the first time, a second computing resource consumption threshold to the organization based on a difference between the organization consumption level at the second time and the first computing resource consumption threshold.

Another example system of any preceding system is provided, further including means for assigning, at a second time after the first time, a second computing resource consumption threshold greater than the first computing resource consumption threshold to the organization based on the detecting operation.

Another example system of any preceding system is provided, wherein the determined prorated share of the first computing resource consumption threshold for each entity is determined based on each entity consumption level relative to the organization consumption level.

Another example system of any preceding system is provided, further including means for assigning, at a second time after the first time, a second computing resource consumption threshold based on the operation of detecting, wherein a difference between the second computing resource consumption threshold and the first computing resources consumption threshold includes a predefined threshold increase buffer.

Another example system of any preceding system is provided, further including means for transmitting, at the first time, to the organization, data representing that the first computing resource consumption threshold was exceeded.

Another example system of any preceding system is provided, further including means for associating each entity with an entity consumption manager, wherein the received confirmation of acceptance of the prorated share assigned to each entity is received based on data stored in each associated entity consumption manager.

While this specification contains many specific implementation details, these should not be construed as limitations on the scope of any technologies or of what may be claimed, but rather as descriptions of features specific to particular implementations of the particular described technology. Certain features that are described in this specification in the context of separate implementations can also be implemented in combination in a single implementation. Conversely, various features that are described in the context of a single implementation can also be implemented in multiple implementations separately or in any suitable sub-combination. Moreover, although features may be described above as acting in certain combinations and even initially claimed as such, one or more features from a claimed combination can in some cases be excised from the combination, and the claimed combination may be directed to a sub-combination or variation of a sub-combination.

The logical operations making up implementations of the technology described herein may be referred to variously as operations, steps, objects, or modules. Furthermore, it should be understood that logical operations may be performed in any order, adding or omitting operations as desired, regardless of whether operations are labeled or identified as optional, unless explicitly claimed otherwise or a specific order is inherently necessitated by the claim language. While operations are depicted in the drawings in a particular order, this should not be understood as requiring that such operations be performed in the particular order shown or in sequential order, or that all illustrated operations be performed, to achieve desirable results. In some cases, the actions recited in the claims can be performed in a different order and still achieve desirable results. In certain circumstances, multitasking and parallel processing may be advantageous. The logical operations making up implementations of the technology described herein may be referred to variously as operations, steps, objects, or modules.

Moreover, the separation of various system components in the implementations described above should not be understood as requiring such separation in all implementations, and it should be understood that the described program components and systems can generally be integrated together in a single software product or packaged into multiple software products. Thus, particular implementations of the subject matter have been described. Other implementations are within the scope of the following claims. Nevertheless, it will be understood that various modifications can be made without departing from the spirit and scope of the recited claims.

As used herein, terms such as “substantially,” “about,” “approximately,” or other terms of relative degree are interpreted as a person skilled in the art would interpret the terms and/or amount to a magnitude of variability of one or more of 1%, 2%, 3%, 4%, 5%, 6%, 7%, 8%, 9%, 10%, 11%, 12%, 13%, 14%, or 15% of a metric relative to the quantitative or qualitative feature described. For example, a term of relative degree applied to orthogonality suggests an angle may have a magnitude of variability relative to a right angle.

What is claimed is:

1. A method of managing consumption of computing resources, the method comprising:
assigning a first computing resource consumption threshold to an organization including entities;
monitoring entity consumption levels of computing resources for each of the entities, wherein the entity consumption levels of computing resources for all of the entities sum to an organization consumption level for the organization;
detecting, at a first time, that the organization consumption level exceeds the first computing resource consumption threshold assigned to the organization;
determining a prorated share of the first computing resource consumption threshold for each entity based on the entity consumption level of each entity and the organization consumption level at the first time;
assigning each prorated share of the first computing resources consumption threshold to the corresponding entity; and
receiving confirmation of acceptance of the prorated share assigned to each entity.

2. The method of claim 1, further comprising:
assigning, at a second time after the first time, a second computing resource consumption threshold to the organization based on a difference between the organization consumption level at the second time and the first computing resource consumption threshold.

3. The method of claim 1, further comprising:
assigning, at a second time after the first time, a second computing resource consumption threshold greater than the first computing resource consumption threshold to the organization based on the operation of detecting.

4. The method of claim 1, wherein the determined prorated share of the first computing resource consumption threshold for each entity is determined based on each entity consumption level relative to the organization consumption level.

5. The method of claim 1, further comprising:
assigning, at a second time after the first time, a second computing resource consumption threshold based on the operation of detecting, wherein a difference between the second computing resource consumption threshold and the first computing resources consumption threshold includes a predefined threshold increase buffer.

6. The method of claim 1, further comprising:
transmitting, at the first time, to the organization, data representing that the first computing resource consumption threshold was exceeded.

7. The method of claim 1, further comprising:
associating each entity with an entity consumption manager, wherein the received confirmation of acceptance of the prorated share assigned to each entity is received based on data stored in each associated entity consumption manager.

8. A system for managing consumption of computing resources, the system comprising:
one or more hardware processors;
a consumption threshold manager executable by the one or more hardware processors and configured to assign a first computing resource consumption threshold to an organization, the organization including entities;
a resource consumption monitor executable by the one or more hardware processors and configured to:
monitor entity consumption levels of computing resources for each of the entities, wherein the entity consumption levels of computing resources for all of the entities sum to an organization consumption level for the organization; and
detect, at a first time, that the organization consumption level exceeds the first computing resource consumption threshold assigned to the organization; and
a consumption threshold share prorater executable by the one or more hardware processors and configured to:
determine a prorated share of the first computing resource consumption threshold for each entity based on the entity consumption level of each entity and the organization consumption level at the first time;
assign each prorated share of the first computing resources consumption threshold to the corresponding entity; and
receiving confirmation of acceptance of the prorated share assigned to each entity.

9. The system of claim 8, wherein the consumption threshold manager is further configured to:
assign, at a second time after the first time, a second computing resource consumption threshold to the organization based on a difference between the organization consumption level at the second time and the first computing resource consumption threshold.

10. The system of claim 8, wherein the consumption threshold manager is further configured to:
assign, at a second time after the first time, a second computing resource consumption threshold greater than the first computing resource consumption threshold to the organization based on the detection.

11. The system of claim 8, wherein the consumption threshold share prorater determines the prorated share of the first computing resource consumption threshold for each entity is based on each entity consumption level relative to the organization consumption level.

12. The system of claim 8, wherein the consumption threshold manager is further configured to:
assign, at a second time after the first time, a second computing resource consumption threshold based on the detection, wherein a difference between the second computing resource consumption threshold and the first computing resources consumption threshold includes a predefined threshold increase buffer.

13. The system of claim 8, wherein the resource consumption monitor is further configured to:
transmit, at the first time, to the organization, data representing that the first computing resources consumption threshold was exceeded.

14. The system of claim 8, further comprising:
an entity consumption manager associated with each entity, wherein the received confirmation of acceptance of the prorated share assigned to each entity is received based on data stored in each associated entity consumption manager.

15. One or more tangible processor-readable storage media devices encoding processor-executable instructions for executing on an electronic computing device a process of managing consumption of computing resources, the process comprising:
assigning a first computing resource consumption threshold to an organization, the organization including entities;
monitoring entity consumption levels of computing resources for each of the entities, wherein the entity consumption levels of computing resources for all of the entities sum to an organization consumption level for the organization;
detecting, at a first time, that the organization consumption level exceeds the first computing resource consumption threshold assigned to the organization;
determining a prorated share of the first computing resource consumption threshold for each entity based on the entity consumption level of each entity and the organization consumption level at the first time;
assigning each prorated share of the first computing resources consumption threshold to the corresponding entity; and
receiving confirmation of acceptance of the prorated share assigned to each entity.

16. The one or more tangible processor-readable storage media devices of claim 15, the process further comprising:
assigning, at a second time after the first time, a second computing resource consumption threshold to the organization based on a difference between the organization consumption level at the second time and the first computing resource consumption threshold.

17. The one or more tangible processor-readable storage media devices of claim 16, wherein the determined prorated share of the first computing resource consumption threshold for each entity is determined based on each entity consumption level relative to the organization consumption level.

18. The one or more tangible processor-readable storage media devices of claim 15, the process further comprising:
assigning, at a second time after the first time, a second computing resource consumption threshold greater than the first computing resource consumption threshold to the organization based on the detection.

19. The one or more tangible processor-readable storage media devices of claim 15, the process further comprising:
assigning, at a second time after the first time, a second computing resource consumption threshold based on the detection, wherein a difference between the second computing resource consumption threshold and the first computing resources consumption threshold includes a predefined threshold increase buffer.

20. The one or more tangible processor-readable storage media devices of claim 15, the process further comprising:
associating each entity with an entity consumption manager, wherein the received confirmation of acceptance of the prorated share assigned to each entity is received based on data stored in each associated entity consumption manager.
